(19) United States
(12) Patent Application Publication
(10) Pub. No.: US 2023/0312298 A1
(43) Pub. Date: Oct. 5, 2023

(54) PERFORATION DEVICE AND SHEET POST-PROCESSING DEVICE INCLUDING THE SAME

(71) Applicant: KYOCERA Document Solutions Inc., Osaka (JP)

(72) Inventor: Rina OKADA, Osaka (JP)

(73) Assignee: KYOCERA Document Solutions Inc., Osaka (JP)

(21) Appl. No.: 18/188,634

(22) Filed: Mar. 23, 2023

(30) Foreign Application Priority Data
Mar. 29, 2022 (JP) 2022-053141

(51) Int. Cl. B65H 35/00; B26F 1/10

(52) U.S. Cl. CPC B65H 35/0086; B26F 1/10; B65H 2403/51; B65H 2403/41; B65H 2513/11; B65H 2511/212; B65H 2553/51

(57) ABSTRACT

A perforation device includes a shaft, a perforation motor, a first perforation unit, a second perforation unit, a first cam, a second cam, a control unit and a perforation switching mechanism. The perforation switching mechanism reciprocates the shaft in an axial direction to selectively arrange the shaft in a first position in which the first cam is opposite the first perforation unit and the second perforation unit and in a second position in which the second cam is opposite the first perforation unit. The perforation switching mechanism includes a rack gear that is attached to the shaft, a perforation switching motor and a pinion gear that is fixed to the rotating shaft of the perforation switching motor and engages with the rack gear. The control unit can selectively perform first perforation processing and second perforation processing by arranging the shaft in the first position and in the second position.

### INCORPORATION BY REFERENCE

This application is based upon and claims the benefit of priority from the corresponding Japanese Patent Application No. 2022-053141 filed on Mar. 29, 2022, the entire contents of which are incorporated herein by reference.

### BACKGROUND

The present disclosure relates to a perforation device which performs perforation processing on sheets and a sheet post-processing device which includes the perforation device.

Conventionally, a sheet post-processing device (finisher) is widely used that is attached to an image forming apparatus and performs predetermined post-processing on a sheet on which image formation has been performed. Some sheet post-processing devices include a perforation device which performs perforation processing (punch hole formation processing) on sheets.

The perforation device includes a perforation blade for perforating a sheet, the protruding perforation blade hits the sheet and thus perforation processing is performed on the sheet. The protruding perforation blade is returned to a retracted position (home position) so as not to interfere with the perforation processing for the subsequent sheet. When a motor is used to perform perforation processing, a configuration is known in which a rotating member that is rotated by the driving force of the motor to reciprocate a perforation blade is provided in a perforation device.

In order to change the number of perforation holes, the perforation device as described above is conventionally equipped with units for two holes and four holes. Disadvantageously, however, the configuration thereof is complicated, and the number of components is increased.

### SUMMARY

A perforation device according to one aspect of the present disclosure includes a shaft, a perforation motor, a plurality of eccentric cams, a plurality of perforation units, a perforation switching mechanism and a control unit, and performs perforation processing on a sheet. The perforation motor rotates the shaft. The eccentric cams are arranged in the shaft along the axial direction of the shaft. The plurality of perforation units are arranged opposite the eccentric cams along the axial direction. The plurality of perforation units includes: perforation blades that are respectively provided in the perforation units to perforate the sheet; and a biasing member that biases the perforation blades in a direction in which the perforation blades approach the eccentric cams, and the perforation units reciprocate the perforation blades according to the rotation of the eccentric cams by the pressing force of the eccentric cams and the biasing force of the biasing member. The perforation switching mechanism causes the shaft to reciprocate in the axial direction to switch the positions of the eccentric cams in the axial direction. The control unit controls the drive of the perforation motor and the perforation switching mechanism. The perforation blades include first perforation blades and second perforation blades. The perforation units include: a plurality of first perforation units that are arranged at a predetermined interval in the axial direction to perform first perforation on the sheet with the first perforation blades; and a plurality of second perforation units that are arranged in positions different from the first perforation units at a predetermined interval in the axial direction to perform second perforation on the sheet with the second perforation blades. The eccentric cams include: a plurality of first cams that reciprocate the first perforation blades of the first perforation units and the second perforation blades of the second perforation units; and a plurality of second cams that reciprocate only the first perforation blades of the first perforation units, and the first cams and the second cams are arranged to be separate from each other with respect to the shaft in the axial direction. The perforation switching mechanism includes: a rack gear that is attached to the shaft with rack teeth formed on a side surface thereof; a perforation switching motor that reciprocates the shaft in the axial direction; and a pinion gear that is fixed to the rotating shaft of the perforation switching motor and engages with the rack gear directly or via an idle gear. The control unit controls the perforation switching mechanism to reciprocate the shaft in the axial direction so as to selectively arrange the shaft in a first position in which the first cams are opposite the first perforation units and the second perforation units and in a second position in which the second cams are opposite the first perforation units. The control unit can selectively perform: first perforation processing in which the shaft is rotated in a state where the shaft is arranged in the first position such that the first perforation and the second perforation is performed on the sheet; and second perforation processing in which the shaft is rotated in a state where the shaft is arranged in the second position such that only the first perforation is performed on the sheet.

### BRIEF DESCRIPTION OF THE DRAWINGS

FIG. 1 is a block diagram showing an example of a control path for a sheet post-processing device which includes a perforation device of the present disclosure and an image forming apparatus to which the sheet post-processing device is attached;

FIG. 2 is a schematic cross-sectional view showing an example of the image forming apparatus to which the sheet post-processing device is attached;

FIG. 3 is a block diagram showing a control path for a perforation device according to an embodiment of the present disclosure;

FIG. 4 is a perspective view when the perforation device of the present embodiment is viewed from an upstream side in a sheet conveying direction;

FIG. 5 is an enlarged view of a rotation speed detection unit and a home position detection unit used in the perforation device of the present embodiment;

FIG. 6 is a side cross-sectional view showing the operation of a first perforation unit and a second perforation unit in the perforation device of the present embodiment and shows a state where a first perforation blade is retracted upward;

FIG. 7 is a side cross-sectional view showing the operation of the first perforation unit and the second perforation unit in the perforation device of the present embodiment and shows a state where the first perforation blade is protruded downward;

FIG. 8 is a perspective view showing the position of a shaft when four-hole perforation is performed in the perforation device of the present embodiment;

FIG. 9 is a perspective view showing the position of the shaft when two-hole perforation is performed in the perforation device of the present embodiment;

FIG. 10 is a side view of a perforation switching mechanism in the perforation device of the present embodiment; and

FIG. 11 is a perspective view of the perforation switching mechanism in the perforation device of the present embodiment.

### DETAILED DESCRIPTION

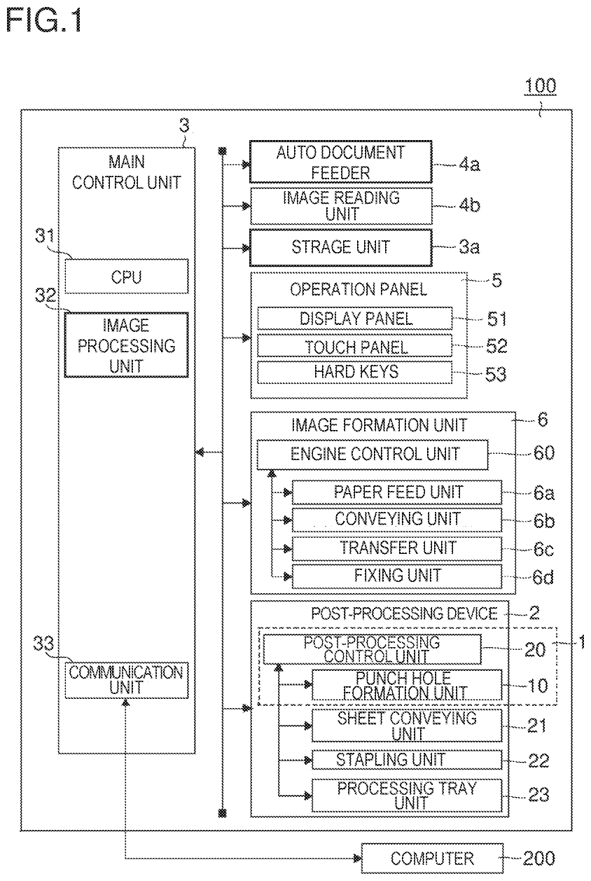

A perforation device 1 according to the present disclosure, a sheet post-processing device 2 which includes the perforation device 1 and an image forming apparatus 100 which is equipped with the sheet post-processing device 2 will be described below with reference to FIGS. 1 to 11. However, elements such as configurations and arrangements described in the present embodiment are not intended to limit the scope of invention and are merely illustrative examples.

### Outline of Image Forming Apparatus

FIG. 1 is a block diagram showing an example of a control path for the sheet post-processing device 2 which includes the perforation device 1 of the present disclosure and the image forming apparatus 100 to which the sheet post-processing device 2 is attached. The control path for the image forming apparatus 100 (here, the multifunctional peripheral) will first be described based on FIG. 1.

The image forming apparatus 100 includes a main control unit 3 and a storage unit 3a. The main control unit 3 comprehensively controls the entire operation of the image forming apparatus 100 and controls the units of the image forming apparatus 100. The main control unit 3 includes a CPU 31, an image processing unit 32 and a communication unit 33. The CPU 31 performs computation on the control to perform the control. The image processing unit 32 performs processing necessary for a job (printing) on image data which is transmitted. The storage unit 3a includes storage devices such as a ROM, a RAM and an HDD. The storage unit 3a stores control programs, the image data and the like. The communication unit 33 is an interface for communicating with a computer 200 such as a PC or a server. The communication unit 33 receives data (printing data) indicating the details of printing such as the image data.

The main control unit 3 is connected to an auto document feeder 4a and an image reading unit 4b to be able to communicate therewith. The auto document feeder 4a conveys a document which is set toward a reading position. The image reading unit 4b can read the document which is conveyed by the auto document feeder 4a and the document which is set on a document stage (unillustrated contact glass). The image reading unit 4b generates the image data. The main control unit 3 controls the operations of the auto document feeder 4a and the image reading unit 4b. The main control unit 3 is connected to the operation panel 5 to be able to communicate therewith. The operation panel 5 includes a display panel 51, a touch panel 52 and hard keys 53. The operation panel 5 receives an operation performed by a user.

The image forming apparatus 100 includes an image formation unit 6. The image formation unit 6 includes an engine control unit 60, a paper feed unit 6a, a conveying unit 6b, a transfer unit 6c and a fixing unit 6d. The engine control unit 60 is connected to the main control unit 3 to be able to communicate therewith. The main control unit 3 transmits a print instruction, the details of a print job and the image data used for printing to the engine control unit 60. Based on the instruction of the main control unit 3, the engine control unit 60 controls the operations of the paper feed unit 6a, the conveying unit 6b, the transfer unit 6c and the fixing unit 6d. Specifically, the engine control unit 60 sequentially performs: a paper feed operation of supplying sheets to the paper feed unit 6a one by one; a conveying operation of conveying the supplied sheet to the conveying unit 6b; an image formation operation of causing the transfer unit 6c to form a toner image; a transfer operation of transferring the toner image to the sheet in the transfer unit 6c; and a fixing operation of fixing, to the fixing unit 6d, the toner image transferred to the sheet.

### Sheet Post-Processing Device 2

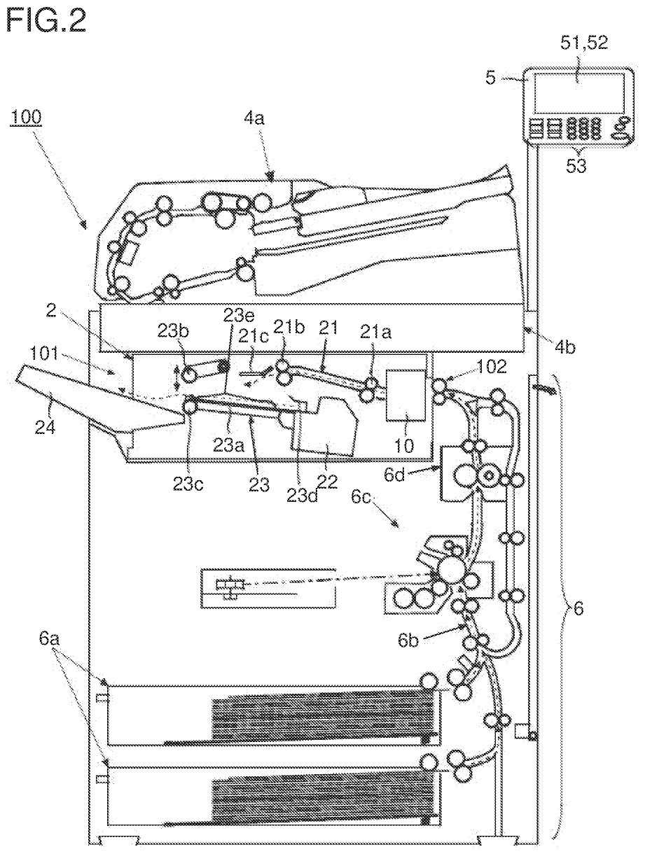

An outline of the sheet post-processing device 2 of the present embodiment will then be described with reference to FIGS. 1 and 2. FIG. 2 is a schematic cross-sectional view showing an example of the image forming apparatus 100 to which the sheet post-processing device 2 of the present embodiment is attached.

The sheet post-processing device 2 performs various types of post-processing on the sheet which has been ejected from the image forming apparatus 100 and on which an image has been formed. The sheet post-processing device 2 is attached to the main body of the image forming apparatus 100. As shown in FIG. 2, the sheet post-processing device 2 is attached to (fitted into) an internal ejection unit 101 in the image forming apparatus 100. There is also a type of sheet post-processing device 2 which is attached to the side surface of the image forming apparatus 100.

The sheet which has passed through the fixing unit 6d and on which the image has been formed is conveyed into the sheet post-processing device 2 from a conveyance inlet 102. The sheet post-processing device 2 includes a punch hole formation unit 10, a sheet conveying unit 21, a stapling unit 22, a processing tray unit 23 and an ejection tray 24. As shown in FIG. 1, the sheet post-processing device 2 includes a post-processing control unit 20 (which corresponds to a control unit). The post-processing control unit 20 is a substrate which includes a processing circuit 2a such as a CPU, a memory 2b and a time-measuring circuit 2c. The post-processing control unit 20 controls the operations of the units of the sheet post-processing device 2. The main control unit 3 or the engine control unit 60 in the image forming apparatus 100 may control the operation of the sheet post-processing device 2 without the provision of the post-processing control unit 20 in the sheet post-processing device 2.

The sheet post-processing device 2 includes the perforation device 1. As shown in FIG. 1, the perforation device 1 includes the post-processing control unit 20 and the punch hole formation unit 10. When a setting for performing perforation processing is made in the operation panel 5, the post-processing control unit 20 uses the punch hole formation unit 10 to perform the perforation processing on the sheet.

The sheet conveying unit 21 conveys the sheet which has passed through the punch hole formation unit 10 to the processing tray unit 23. The sheet conveying unit 21 includes a first conveying roller pair 21a, a second conveying roller pair 21b and a sheet conveying guide 21c. The processing tray unit 23 includes a processing tray 23a, a first ejection roller 23b, a second ejection roller 23c, a stopper 23d and a width regulation plate 23e. The post-processing control unit 20 aligns and ejects a bundle of sheets conveyed and stacked on the processing tray unit 23. When stapling processing is set in the operation panel 5, the post-processing control unit 20 uses the stapling unit 22 to perform the stapling processing on the bundle of sheets stacked on the processing tray unit 23 before the ejection.

### Perforation Device 1

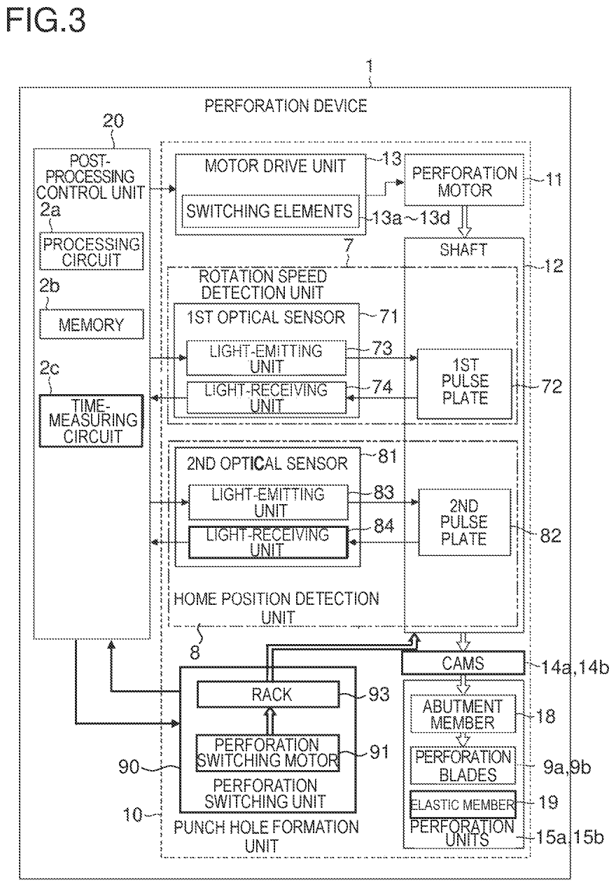

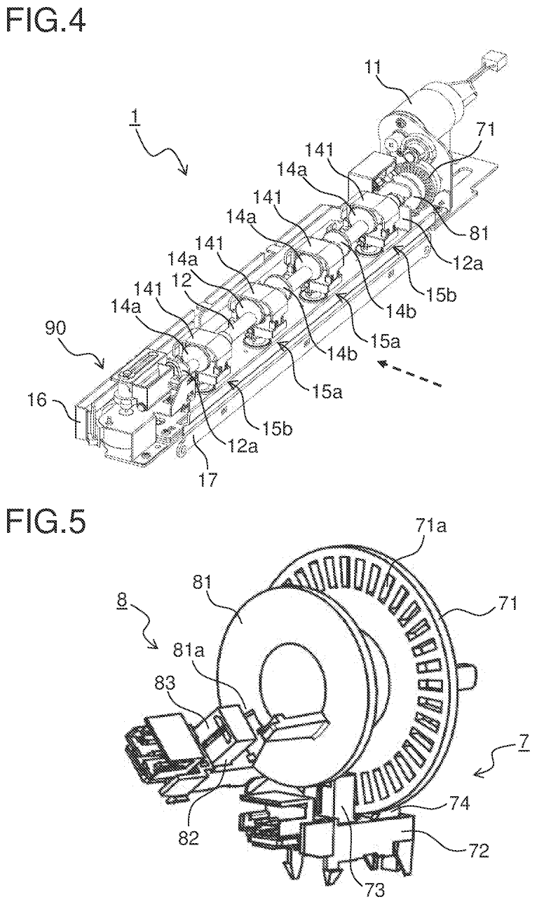

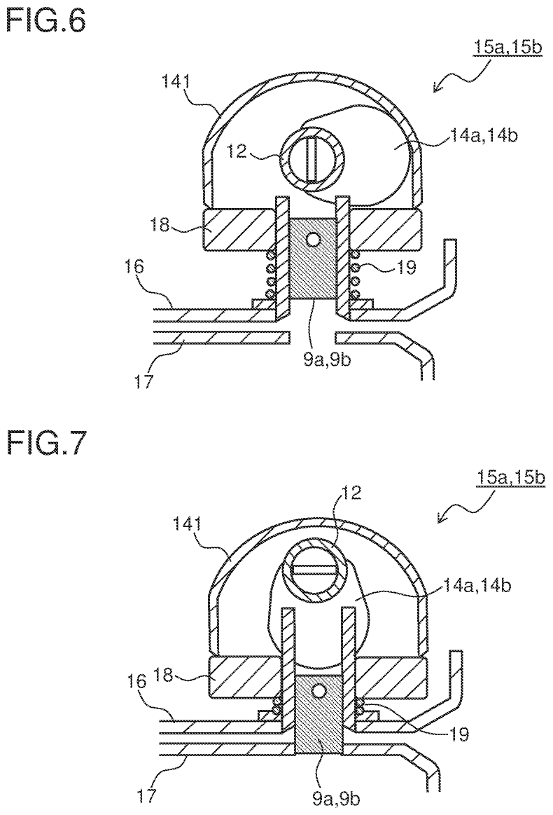

The perforation device 1 of the present embodiment will then be described with reference to FIGS. 3 to 9. FIG. 3 is a block diagram showing an example of a control path for the perforation device 1 according to the embodiment of the present disclosure. FIG. 4 is a perspective view showing an example of the perforation device 1 of the present embodiment. FIG. 4 is the perspective view when the perforation device 1 is viewed from an upstream side in a sheet conveying direction, and the direction of entry of the sheet is indicated by a broken-line arrow. FIG. 5 is an enlarged view of a rotation speed detection unit 7 and a home position detection unit 8 used in the perforation device 1 of the present embodiment. FIGS. 6 and 7 are side cross-sectional views showing the operation of a first perforation unit 15a and a second perforation unit 15b in the perforation device 1 of the present embodiment.

As shown in FIG. 3, the perforation device 1 includes the post-processing control unit 20 and the punch hole formation unit 10. The punch hole formation unit 10 includes a perforation motor 11, a shaft 12, a motor drive unit 13, cams 14a and 14b, perforation units 15a and 15b, the rotation speed detection unit 7, the home position detection unit 8 and a perforation switching mechanism 90. The perforation units 15a and 15b include perforation blades 9a and 9b, respectively. White arrows in FIG. 3 indicate a transmission path for driving forces from the perforation motor 11 and a perforation switching motor 91.

The perforation motor 11 reciprocates the perforation blades 9a and 9b. For example, a DC brush motor can be used as the perforation motor 11. The motor drive unit 13 includes a plurality of (here, four) switching elements 13a to 13d. The switching elements 13a to 13d turn on and off the supply of current to the perforation motor 11. The post-processing control unit 20 controls the switching elements 13a to 13d. The post-processing control unit 20 controls the motor drive unit 13 to perform the brake control of the perforation motor 11.

As shown in FIG. 4, the perforation device 1 includes an upper guide unit 16 and a lower guide unit 17 which are arranged opposite each other at a predetermined interval. In an upper portion of the upper guide unit 16, a plurality of perforation units 15a and 15b are provided, and here, an example where four perforation units 15a and 15b are provided is shown (which corresponds to a four-hole system). Specifically, the perforation units 15a and 15b are composed of a plurality of (here, a pair of) first perforation units 15a which form two holes in a center portion of the sheet in a width direction and a plurality of (here, a pair of) second perforation units 15b which form two holes in both end portions of the sheet in the width direction. The first perforation units 15a and the second perforation units 15b perform the perforation processing on the sheet which passes between the upper guide unit 16 and the lower guide unit 17. In the following description, the perforation blades 9a and 9b arranged in the first perforation unit 15a and the second perforation unit 15b are respectively referred to as the first perforation blade 9a and the second perforation blade 9b to be distinguished from each other.

The shaft 12 is arranged so as to straddle the top of the first perforation units 15a and the second perforation units 15b. The shaft 12 is rotatably supported by a shaft support member 12a. The cams 14a and 14b are attached to the shaft 12. The cams 14a and 14b are composed of first cams 14a and second cams 14b. The first cams 14a are attached to four parts of the shaft 12 in the axial direction, and are arranged to correspond to two inner first perforation units 15a and two outer second perforation units 15b. The second cams 14b are attached to two parts of the shaft 12 in the axial direction, and are arranged adjacent to the first cams 14a corresponding to the two first perforation unit 15a. On the tops of the first perforation units 15a and the second perforation units 15b, cam covers 141 which cover the first cams 14a and the second cams 14b are attached. When the first perforation blades 9a and the second perforation blades 9b are raised, the first cams 14a and the second cams 14b are rotated upward while sliding along the inner wall surfaces of the cam covers 141. In other words, the cam covers 141 function as guides for assisting the movements of the first cams 14a and the second cams 14b when the first perforation blades 9a and the second perforation blades 9b are pushed up by the biasing force of a coil spring 19.

The shaft 12 is coupled to the rotating shaft of the perforation motor 11 via a gear. The perforation motor 11 rotates the shaft 12, and thus the first cams 14a and the second cams 14b are rotated together with the shaft 12. For example, when the perforation motor 11 is rotated one revolution, the shaft 12 is rotated one revolution.

As shown in FIG. 5, the rotation speed detection unit 7 detects the rotation speed of the shaft 12 (the perforation motor 11). The rotation speed detection unit 7 includes a first pulse plate 71 and a first sensor unit 72. The first sensor unit 72 is a transmissive optical sensor. The first sensor unit 72 includes a light-emitting unit 73 and a light-receiving unit 74. The first pulse plate 71 is attached to the shaft 12. The light-emitting unit 73 and the light-receiving unit 74 are arranged to sandwich the outer circumferential edge of the first pulse plate 71 attached to the shaft 12.

The first pulse plate 71 is held such that the rotation of the first pulse plate 71 with respect to the shaft 12 in a circumferential direction is regulated and the first pulse plate 71 is slidable in the axial direction. In this way, as described later, when the shaft 12 is reciprocated in the axial direction, the first pulse plate 71 is not moved in the axial direction, and thus a positional relationship between the first pulse plate 71 and the first sensor unit 72 is not changed. As a method for holding the first pulse plate 71 such that the first pulse plate 71 is slidable with respect to the shaft 12 only in the axial direction, for example, a configuration is mentioned in which a rib extending in the axial direction is formed on the outer circumferential surface of the shaft 12 and a groove which slidably engages with the rib is formed in the first pulse plate 71.

In the first pulse plate 71, a plurality of slits 71a are provided. For example, the number of slits 71a is several tens to several hundreds (for example, 40 to 50). The slits 71a are provided in the outer circumferential edge of the first pulse plate 71 sandwiched between the light-emitting unit 73 and the light-receiving unit 74. The slits 71a are formed at regular angles, and each time the shaft 12 is rotated the angle, the output of the first sensor unit 72 (the light-receiving unit 74) is changed. The output of the light-receiving unit 74 when the first pulse plate 71 is rotated between the light-emitting unit 73 and the light-receiving unit 74 is the output of the rotation speed detection unit 7. The output of the light-receiving unit 74 is a pulse signal which rises or falls each time the shaft 12 (the perforation motor 11) is rotated the angle. The output of the light-receiving unit 74 is input to the post-processing control unit 20. The post-processing control unit 20 detects, based on the output of the first sensor unit 72, that the shaft 12 is rotated the angle.

Based on the period of the pulses of the pulse signals, the post-processing control unit 20 detects the rotation speed of the shaft 12 (the perforation motor 11). More specifically, the post-processing control unit 20 detects the rotation speed of the shaft 12 based on a time interval between the rising or falling edges of the pulse signals. Hence, the time-measuring circuit 2c in the post-processing control unit 20 measures the period (interval between the edges) of the pulse signals.

A case where the rotation speed (rps) of the shaft 12 per second is determined will be described. In this case, the post-processing control unit 20 divides one (second) by the period of one pulse. In this way, the number of pulses A per second at the current period is calculated. Then, the post-processing control unit 20 divides the number of pulses A by the number of pulses B (the number of slits of the first pulse plate 71) generated when the shaft 12 is rotated one revolution. In this way, it is possible to determine the rotation speed of the shaft 12. In order to determine rpm, the result is multiplied by 60. For example, when the period of one pulse is 10 milliseconds, the number of pulses A=100. When the number of pulses B is 50, the number of revolutions per second=100/50=2 [rps].

The home position detection unit 8 detects that the rotation angle of the shaft 12 (the perforation motor 11) is a predetermined reference angle to determine whether or not the perforation blades 9 are located in the home position. The home position detection unit 8 includes a second pulse plate 81 and a second sensor unit 82. The second sensor unit 82 is a transmissive optical sensor. The second sensor unit 82 includes a light-emitting unit 83 and a light-receiving unit 84 (see FIG. 3). The light-emitting unit 83 and the light-receiving unit 84 are arranged to sandwich the outer circumferential edge of the second pulse plate 81 attached to the shaft 12.

The second pulse plate 81 is held such that the rotation of the second pulse plate 81 with respect to the shaft 12 in the circumferential direction is regulated and the second pulse plate 81 is slidable in the axial direction. In this way, as described later, when the shaft 12 is reciprocated in the axial direction, the second pulse plate 81 is not moved in the axial direction, and thus a positional relationship between the second pulse plate 81 and the second sensor unit 82 is not changed. As a method for holding the second pulse plate 81 such that the second pulse plate 81 is slidable with respect to the shaft 12 only in the axial direction, the same method as that for the first pulse plate 71 described above is mentioned.

A cutout 81a is provided in the outer circumferential edge of the second pulse plate 81. The cutout 81a is formed in such a position that when the angle of the shaft 12 is the reference angle, the output of the second sensor unit 82 (the light-receiving unit 84) is changed. The output of the light-receiving unit 84 when the second pulse plate 81 is rotated between the light-emitting unit 83 and the light-receiving unit 84 is the output of the home position detection unit 8. The output of the light-receiving unit 84 is transmitted to the post-processing control unit 20 as a detection signal. Based on the output of the home position detection unit 8, the post-processing control unit 20 detects that the angle of the shaft 12 is the reference angle.

In the present embodiment, in order to detect one revolution of the shaft 12 in two-hole perforation and four-hole perforation, the cutout 81a is provided in one part of the second pulse plate 81.

Here, the position in which the conveyed sheet is not in contact with the first perforation blades 9a and the second perforation blades 9b is set to the home position of the perforation blades 9. In other words, when the first perforation blades 9a and the second perforation blades 9b are in the home position, the first perforation blades 9a of the first perforation units 15a and the second perforation blades 9b of the second perforation units 15b are retracted (separate) form the sheet.

Specifically, the home position is the range of positions which can be taken by the first perforation blades 9a and the second perforation blades 9b when after the home position detection unit 8 detects that the shaft 12 is at the reference angle, the output of the rotation speed detection unit 7 rotates the shaft 12 in a forward direction only by a predetermined number of pulses (number of positioning pulses). For example, when the number of positioning pulses is assumed to be 2, the reference angle is the angle of the shaft 12 when the shaft 12 is rotated backward by an angle corresponding to two pulses of the rotation speed detection unit 7 from positions at which the first perforation blades 9a and the second perforation blades 9b serve as the home position. Hence, when the shaft 12 is rotated forward by an angle corresponding to one pulse or three pulses from the reference angle, the first perforation blades 9a and the second perforation blades 9b are outside the home position. When the number of slits 71a in the first pulse plate 71 is 36, the rotation angle per pulse is 360/36=10°.

When the main power of the image forming apparatus 100 or the sheet post-processing device 2 is turned on, the post-processing control unit 20 performs startup processing. The startup processing includes processing for bringing the perforation blades 9 into the home position. In this case, the post-processing control unit 20 rotates the perforation motor 11 forward at low speed, and after the home position detection unit 8 detects that the shaft 12 is at the reference angle, the perforation motor 11 is stopped when the output of the rotation speed detection unit 7 is changed only by the number of positioning pulses.

As shown in FIGS. 6 and 7, each of the first perforation unit 15a and the second perforation unit 15b includes the first perforation blade 9a/second perforation blade 9b, an abutment member 18 and the coil spring (biasing member) 19. Each of the first perforation blade 9a and the second perforation blade 9b is, for example, a metal pipe, and a blade is formed in a lower end portion. The abutment member 18 is provided above the first perforation blade 9a/second perforation blade 9b, and an upper end portion of the first perforation blade 9a/second perforation blade 9b is fixed to the abutment member 18.

In the upper guide unit 16 and the lower guide unit 17, a hole (not shown) is opened in a position opposite the first perforation blade 9a/second perforation blade 9b. The first perforation blade 9a/second perforation blade 9b is moved downward such that the lower end portion of the first perforation blade 9a/second perforation blade 9b hits the sheet, and the first perforation blade 9a/second perforation blade 9b is further moved downward, with the result that the sheet is perforated. The first perforation blade 9a/second perforation blade 9b is retracted upward after the perforation so as not to prevent the perforation processing on the subsequent sheet to be conveyed.

The abutment member 18 is provided below the shaft 12, the first cam 14a and the second cam 14b. As shown in FIG. 6, each of the first cam 14a and the second cam 14b is in an elliptical shape when viewed in the axial direction of the shaft 12, and the outer circumferential surfaces of the first cam 14a and the second cam 14b make contact with the upper surface of the abutment member 18. The abutment member 18 is biased upward by the coil spring 19. When the shaft 12 is rotated by the drive force of the perforation motor 11, the outside diameters of the first cam 14a and the second cam 14b of the portions which make contact with the abutment member 18 are changed according to the rotation angle of the shaft 12. In other words, the amount of pressure caused by the first cam 14a and the second cam 14b on the abutment member 18 is changed according to the rotation angle of the shaft 12.

As shown in FIG. 6, in a state where small-diameter portions of the first cam 14a and the second cam 14b make contact with the abutment member 18, the abutment member 18 is raised by the biasing force of the coil spring 19, and thus the first perforation blade 9a/second perforation blade 9b is retracted upward. On the other hand, as shown in FIG. 7, in a state where large-diameter portions of the first cam 14a and the second cam 14b make contact with the abutment member 18, the abutment member 18 is pushed down against the biasing force of the coil spring 19, and thus the first perforation blade 9a/second perforation blade 9b is protruded downward. As described above, the first perforation blade 9a/second perforation blade 9b is reciprocated according to the rotation of the first cam 14a and the second cam 14b.

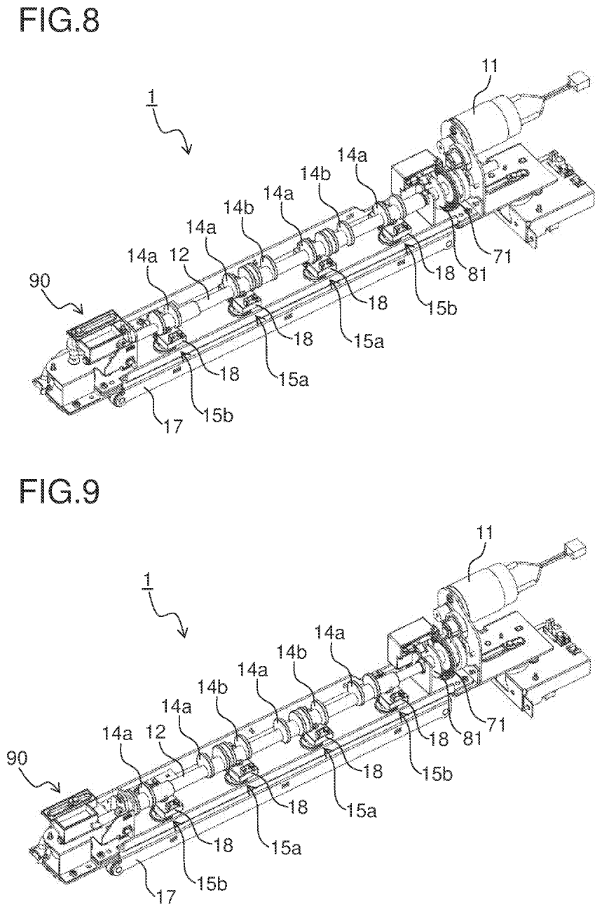

FIGS. 8 and 9 are respectively perspective views showing the positions of the shaft 12 when four-hole perforation and two-hole perforation are performed in the perforation device 1 of the present embodiment. For ease of description, in FIGS. 8 and 9, the first perforation blades 9a, the second perforation blades 9b, the coil spring 19 and the cam covers 141 are omitted. With reference to FIGS. 6 to 9, a description will be given below of switching between four-hole perforation (first perforation processing) for forming a total of four holes, that is, two holes in a center portion of the sheet in a width direction and two holes in both end portions of the sheet in the width direction and two-hole perforation (second perforation processing) for forming two holes in the center portion of the sheet in the width direction in the perforation device 1 of the present embodiment.

When the four-hole perforation is performed, as shown in FIG. 8, the shaft 12 is arranged in such a position (first position) that the first cams 14a attached to the four parts of the shaft 12 abut on the abutment members 18 of the first perforation units 15a and the second perforation units 15b. In this state, the forward rotation of the shaft 12 is started from a state where the first perforation blades 9a and the second perforation blades 9b are in the home position (see FIG. 6, the position rotated from the detection timing of the cutout 81a only by the number of positioning pulses). In this way, the first cams 14a push down the first perforation blades 9a and the second perforation blades 9b together with the abutment members 18. Then, when the shaft 12 is rotated 90° from the home position, the first perforation blades 9a and the second perforation blades 9b are moved down to such a position (see FIG. 7, the lower portion of the lower guide unit 17) as to penetrate the sheet. Consequently, two inner holes are formed by the two first perforation units 15a, and two outer holes are formed by the two second perforation units 15b.

Thereafter, when the post-processing control unit 20 further rotates the shaft 12 forward, the amount by which the first cams 14a push down the abutment members 18 is reduced. In this way, the first perforation blades 9a and the second perforation blades 9b are moved upward by the biasing force of the coil spring 19. When the forward rotation of the shaft 12 is continued, the second perforation blades 9b of the second perforation units 15b are raised to such a position (the upper portion of the upper guide unit 16) as not to block the conveyance of the sheet. The post-processing control unit 20 stops the perforation motor 11 such that the first perforation blades 9a and the second perforation blades 9b are in the home position. The operation described above is repeated, and thus the four-hole perforation is performed by the two first perforation unit 15a and the two second perforation unit 15b.

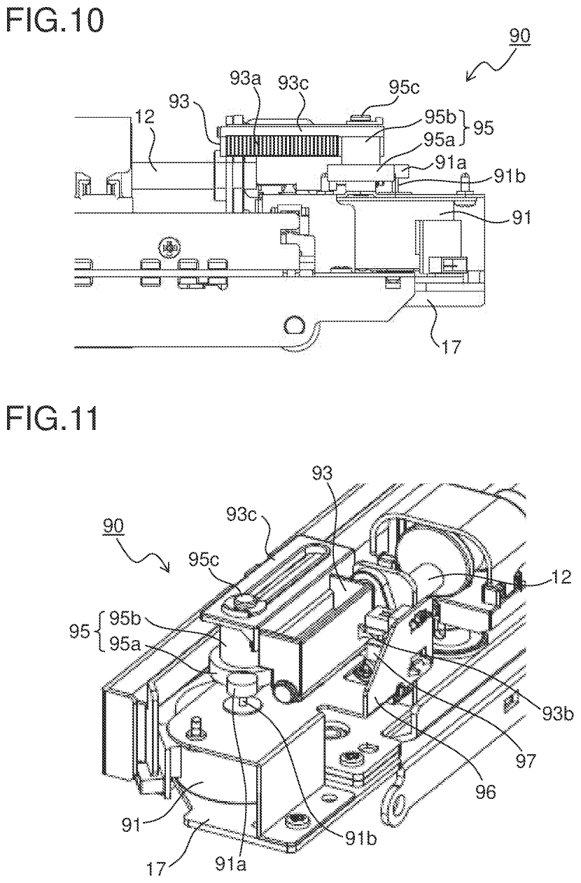

When the two-hole perforation is performed, the perforation switching motor 91 (see FIG. 10) is rotated forward, and thus as shown in FIG. 9, the shaft 12 is moved from the state of FIG. 8 in the axial direction only by a predetermined amount. Then, the shaft 12 is arranged in such a position (second position) that the second cams 14b attached to the two parts of the shaft 12 abut on the abutment members 18 of the first perforation units 15a. Here, the first cams 14a attached to the four parts are arranged in positions displaced from the first perforation units 15a and the second perforation units 15b in the axial direction.

In this state, the forward rotation of the shaft 12 is started from a state where the first perforation blades 9a are in the home position (see FIG. 6). In this way, the second cams 14b push down the first perforation blades 9a together with the abutment members 18. Then, when the shaft 12 is rotated 90° from the home position, the first perforation blades 9a are moved down to such a position (see FIG. 7) as to penetrate the sheet. Consequently, two inner holes are formed by the two first perforation units 15a.

Thereafter, when the post-processing control unit 20 further rotates the shaft 12 forward, the amount by which the second cams 14b push down the abutment members 18 is reduced. In this way, the first perforation blades 9a are moved upward by the biasing force of the coil spring 19. When the forward rotation of the shaft 12 is continued, the first perforation blades 9a of the first perforation unit 15a are raised to such a position (the upper portion of the upper guide unit 16) as not to block the conveyance of the sheet. The post-processing control unit 20 stops the perforation motor 11 such that the first perforation blades 9a are in the home position. The operation described above is repeated, and thus the two-hole perforation is performed by the two first perforation unit 15a.

FIG. 10 is a side view of the perforation switching mechanism 90 in the perforation device 1 of the present embodiment. FIG. 11 is a perspective view of the perforation switching mechanism 90 in the perforation device 1 of the present embodiment. As shown in FIGS. 10 and 11, the perforation switching mechanism 90 includes the perforation switching motor 91, a rack gear 93 and an idle gear 95.

The perforation switching motor 91 is fixed to the lower guide unit 17 by a motor holding frame 96. A pinion gear 91a is fixed to the rotating shaft 91b of the perforation switching motor 91.

The rack gear 93 is held on one end (front side of the plane of FIGS. 8 and 9) of the shaft 12. The rack gear 93 includes rack teeth 93a, a light blocking plate 93b and a guide portion 93c. The rack teeth 93a are formed on a surface (front side of the plane of FIG. 10) opposite to the idle gear 95, and engage with the small-diameter portion 95b of the idle gear 95. The light blocking plate 93b is formed on a surface opposite to the motor holding frame 96. As the shaft 12 is reciprocated in the axial direction, the light blocking plate 93b transmits and blocks light to the detection unit of a shaft position detection sensor 97 arranged in the motor holding frame 96. The post-processing control unit 20 detects, based on the output of the shaft position detection sensor 97, the movement of the shaft 12 to the first position or the second position.

The idle gear 95 is a two-stage gear which includes a large-diameter portion 95a and the small-diameter portion 95b. The large-diameter portion 95a of the idle gear 95 engages with the pinion gear 91a. The small-diameter portion 95b of the idle gear 95 engages with the rack teeth 93a. In this configuration, the rotational driving force of the perforation switching motor 91 is transmitted via the idle gear 95 to the rack gear 93. The perforation switching motor 91 is rotated forward and backward, and thus the shaft 12 is reciprocated together with the rack gear 93 in the axial direction, with the result that the shaft 12 is arranged in the first position (see FIG. 8) and in the second position (see FIG. 9).

The rack gear 93 is held such that the movement of the rack gear 93 with respect to the shaft 12 in the axial direction is regulated and the rack gear 93 is slidable in a circumferential direction. The rotating shaft 95c of the idle gear 95 slidably engages with the guide portion 93c. In this way, when the shaft 12 is rotated, the rack gear 93 is not rotated together, and when the shaft 12 is reciprocated in the axial direction, a positional relationship between the rack teeth 93a and the idle gear 95 is not changed. Hence, regardless of the phase (rotation angle) of the shaft 12, the engagement state of the rack teeth 93a and the idle gear 95 can be maintained.

As a method for holding the rack gear 93 such that the rack gear 93 is slidable with respect to the shaft 12 only in the circumferential direction, for example, a configuration is mentioned in which the shaft 12 is inserted into a through-hole formed in the rack gear 93 to attach the rack gear 93 to the shaft 12, stop rings (not shown) are fitted and fixed into locking grooves (not shown) formed in two parts of the shaft 12 in the axial direction and thus the movement of the rack gear 93 in the axial direction is regulated. As the configuration for regulating the rotation of the rack gear 93 around the shaft 12, a configuration is mentioned in which the rotating shaft 95c of the idle gear 95 is inserted into the guide portion 93c of the rack gear 93 and thereafter a stop ring (not shown) is fitted and fixed to the rotating shaft 95c.

In the perforation device 1 of the present embodiment, the shaft 12 includes: the first cams 14a which are arranged to correspond to the two inner first perforation units 15a and the two outer second perforation units 15b; and the second cams 14b which are arranged to correspond to only the first perforation units 15a. In a state where the shaft 12 is arranged in the first position in which the first cams 14a abut on the abutment members 18 of the first perforation units 15a and the second perforation units 15b, the shaft 12 is rotated one revolution, and thus the four-hole perforation is performed with the first perforation units 15a and the second perforation units 15b. Moreover, in a state where the shaft 12 is arranged in the position (second position) in which the second cams 14b abut on the abutment members 18 of the first perforation units 15a, the shaft 12 is rotated one revolution, and thus the two-hole perforation is performed with the first perforation units 15a.

In this way, only by reciprocating the shaft 12 in the axial direction to arrange the shaft 12 in the first position and the second position, it is possible to switch between the four-hole perforation and the two-hole perforation. Hence, the time necessary for switching perforation patterns is reduced, and thus it is possible to enhance processing efficiency (productivity).

As compared with a configuration in which the shaft 12 is moved in a forward/backward direction (conveying direction) to switch perforation patterns, it is possible to reduce the size of the perforation device 1. Furthermore, as the perforation switching mechanism 90, a gear mechanism (rack and pinion mechanism) as shown in FIG. 10 is used, and thus even when the position of the shaft 12 is lowered, as compared with a configuration using a solenoid, it is possible to secure a switching stroke, with the result that the present disclosure is advantageous in that the size of the perforation switching mechanism 90 is reduced.

The present disclosure is not limited to the embodiment described above, and various changes can be made without departing from the spirit of the present disclosure. For example, although in the embodiment described above, the two first perforation units 15a and the two second perforation units 15b are used to form the four holes along the width direction of the sheet, the two first perforation units 15a are used to form the two holes in the center portion of the sheet in the width direction and thus the four-hole perforation and the two-hole perforation are switched, the locations and the number of the first perforation units 15a and the second perforation units 15b can be arbitrarily set.

Although in the embodiment described above, as the perforation switching mechanism 90, the perforation switching motor 91, the rack gear 93 and the idle gear 95 are provided, the present disclosure is not limited to this configuration, and two or more idle gears 95 may be provided. The pinion gear 91a of the perforation switching motor 91 may directly engage with the rack teeth 93a of the rack gear 93.

The present disclosure can be utilized for a perforation device and a sheet post-processing device including a perforation device. The present disclosure is utilized, and thus it is possible to switch perforation patterns for a sheet with a compact configuration, with the result that it is possible to provide a perforation device and a sheet post-processing device including such a perforation device which can reduce a switching time.

What is claimed is:

1. A perforation device that performs perforation processing on a sheet, the perforation device comprising:
a shaft;
a perforation motor that rotates the shaft;
a plurality of eccentric cams that are arranged on the shaft along an axial direction of the shaft;
a plurality of perforation units that are arranged opposite the eccentric cams along the axial direction, the plurality of perforation units including:
perforation blades that are respectively provided in the perforation units to perforate the sheet; and
biasing members that biase the perforation blades in a direction in which the perforation blades approach the eccentric cams, the plurality of perforation units reciprocating the perforation blades according to rotation of the eccentric cams by a pressing force of the eccentric cams and a biasing force of the biasing members;
a perforation switching mechanism that causes the shaft to reciprocate in the axial direction to switch positions of the eccentric cams in the axial direction; and
a control unit that controls drive of the perforation motor and the perforation switching mechanism,
wherein the perforation blades include first perforation blades and second perforation blades;
wherein the plurality of perforation units include:
a plurality of first perforation units that are arranged at a predetermined interval in the axial direction to perform first perforation on the sheet with the first perforation blades; and
a plurality of second perforation units that are arranged in positions different from the first perforation units at a predetermined interval in the axial direction to perform second perforation on the sheet with the second perforation blades,
the eccentric cams include:
a plurality of first cams that reciprocate the first perforation blades of the first perforation units and the second perforation blades of the second perforation units; and
a plurality of second cams that reciprocate only the first perforation blades of the first perforation units, and the first cams and the second cams are arranged to be separate from each other with respect to the shaft in the axial direction,
the perforation switching mechanism includes:
a rack gear that is attached to the shaft with rack teeth formed on a side surface thereof;
a perforation switching motor that reciprocates the shaft in the axial direction; and
a pinion gear that is fixed to a rotating shaft of the perforation switching motor and engages with the rack gear directly or via an idle gear,
the control unit controls the perforation switching mechanism to reciprocate the shaft in the axial direction so as to selectively arrange the shaft in a first position in which the first cams are opposite the first perforation units and the second perforation units and in a second position in which the second cams are opposite the first perforation units and
the control unit can selectively perform:
first perforation processing in which the shaft is rotated in a state where the shaft is arranged in the first position such that the first perforation and the second perforation is performed on the sheet; and
second perforation processing in which the shaft is rotated in a state where the shaft is arranged in the second position such that only the first perforation is performed on the sheet.

2. The perforation device according to claim 1,
wherein the rack gear is held with respect to the shaft such that movement of the rack gear in the axial direction is restricted and rotation of the rack gear in a circumferential direction is allowed.

3. The perforation device according to claim 2,
wherein the pinion gear engages with the rack gear via the idle gear, and the rack gear includes a guide portion with which a rotating shaft of the idle gear slidably engages along the axial direction.

4. The perforation device according to claim 1,
wherein the first perforation units include a pair of the first perforation units arranged at a center portion in a sheet width direction, and the second perforation units include a pair of the second perforation units arranged at both end portions in the sheet width direction, and
the first perforation processing is four-hole perforation in which the pair of the first perforation units and the pair of the second perforation units are used to form four holes on the sheet in the sheet width direction, and the second perforation processing is two-hole perforation in which the pair of the first perforation units are used to form two holes on the sheet in the sheet width direction.

5. The perforation device according to claim 1, comprising:
a rotation speed detection unit that detects a rotation speed of the shaft; and
a home position detection unit that detects whether or not the first perforation blades and the second perforation blades are located in a home position in which the first perforation blades and the second perforation blades are separate from the sheet,
wherein each of the rotation speed detection unit and the home position detection unit includes:
a pulse plate that is rotated together with the shaft; and
a sensor unit that is arranged to sandwich an outer circumferential edge of the pulse plate, and
the pulse plate is held on the shaft such that rotation of the pulse plate with respect to the shaft in a circumferential direction is restricted and movement of the pulse plate in the axial direction is allowed.

6. A sheet post-processing device comprising the perforation device according to claim 1.
